(19) United States
(12) Patent Application Publication
(10) Pub. No.: US 2025/0125510 A1
(43) Pub. Date: Apr. 17, 2025

(54) PRISMATIC BATTERY CELL HAVING A ONE-WAY VALVE

(71) Applicant: GM Global Technology Operations LLC, Detroit, MI (US)

(72) Inventors: Subrahmanyam Goriparti, Troy, MI (US); Raghavendra Keerthi Manda, Northville, MI (US)

(21) Appl. No.: 18/485,493

(22) Filed: Oct. 12, 2023

(51) Int. Cl. H01M 50/645; H01M 50/103; H01M 50/184; H01M 50/186; H01M 50/193; H01M 50/325

(52) U.S. Cl. CPC H01M 50/645; H01M 50/103; H01M 50/184; H01M 50/186; H01M 50/193; H01M 50/325

(57) ABSTRACT

A prismatic battery cell has a cell case, an electrolyte, and a sealing member. The cell case has an interior cavity and a fill port. The fill port has an inner surface. The fill port is in fluid communication with an ambient environment and the interior cavity. The electrolyte is disposed in the interior cavity through a one-way valve in the sealing member. The sealing member is disposed in the fill port. The sealing member has an exterior sealing surface that forms a fluid seal with the inner surface of the fill port. The sealing member has a valve formed therein. The valve has an open position for allowing the electrolyte to enter the interior cavity and a closed position to prevent the electrolyte from exiting the interior cavity. Moreover, the valve allows for degassing of the battery cell after the formation process.

### INTRODUCTION

The present disclosure relates to a prismatic battery cell and more particularly to a prismatic battery cell that has a device and method to fill the battery cell with an electrolyte during manufacture.

A rechargeable energy storage system (RESS), for example a prismatic battery cell, includes typically a plurality of electrode stacks. Each of the electrode stacks includes an anode and a cathode spaced apart by an electrically insulative separator material. The electrode stacks are placed next to one another typically in a case or enclosure to protect the electrode stacks from the ambient environment. The case also functions to contain an electrolyte fluid within the case and around the electrode stacks. The electrolyte is deposited into the case of the battery cell through a fill port. During manufacturing of the prismatic battery cell an electrolyte fill tool (i.e. a funnel, needle or tube) is inserted into the fill port, the battery cell is filled with the electrolyte through the fill tool, the fill tool is extracted from the fill port, a temporary insert (i.e. a sealing plug) is positioned in the fill port to prevent the contents of the case from escaping through the fill port, a formation process is initiated by applying a current to the electrodes at a specified time duration, the temporary insert is removed from the fill port, gasses are released from the case through the fill port, the fill tool is re-inserted into the fill port, the battery cell is filled with the electrolyte a second time or multiple times as needed, the fill tool is extracted from the fill port, a gasket insert or plug is applied to the fill port, a closure plate is applied over the gasket insert and welded to the battery cell case.

While prior art methods and systems for manufacturing battery cells may achieve their particular purposes a need still exists for a new and improved battery cell and battery cell manufacturing process. Accordingly, a battery cell manufacturing process that includes fewer manufacturing steps is needed, for example.

### SUMMARY

According to several aspects of the present disclosure, a prismatic battery cell is provided. The prismatic battery cell includes a cell case, an electrolyte, and a sealing member. The cell case has an interior cavity and a fill port. The fill port has an inner surface. The fill port is in fluid communication with an ambient environment and the interior cavity. The electrolyte is disposed in the interior cavity. The sealing member is disposed in the fill port. The sealing member has an exterior sealing surface that forms a fluid seal with the inner surface of the fill port. The sealing member has a valve formed therein. The valve has an open position for allowing the electrolyte to enter the interior cavity and a closed position to prevent the electrolyte from exiting the interior cavity.

In accordance with another aspect of the present disclosure, the prismatic battery further includes a closure plate disposed over and covering the sealing member.

In accordance with another aspect of the present disclosure the closure plate is secured to the cell case to form a mechanical and a fluid seal between the cell case and the interior cavity.

In accordance with another aspect of the present disclosure the inner surface of the fill port includes a first annular surface and a second annular surface.

In accordance with another aspect of the present disclosure the exterior sealing surface of sealing member has a first sealing annular surface that forms a first fluid seal with the first annular surface of the fill port.

In accordance with another aspect of the present disclosure, the sealing member has a second sealing annular surface that forms a second fluid seal with the second annular surface of the fill port.

In accordance with another aspect of the present disclosure, the first sealing annular surface of the exterior sealing surface of sealing member is formed on an annular rim at a first end of the sealing member.

In accordance with another aspect of the present disclosure, the second sealing annular surface of the exterior sealing surface of sealing member is formed on a conical portion of the sealing member at a second end of the sealing member.

In accordance with another aspect of the present disclosure, the valve further includes a tubular body having an inner annular rim at a first end. The inner annular rim forms an annulus. A flap is disposed at a second end of the tubular body. The flap is sealed against the tubular body in the closed position of the valve to form a fluid seal and the flap and disposed away from the tubular body in the open position of the valve to allow for fluid communication with the interior cavity.

In accordance with another aspect of the present disclosure, the sealing member is formed of at least one of a polymer and a polymer composite. The at least one of a polymer and a polymer composite includes, for example, at least one of a silicone and a polyphenylene sulfide or similar material.

In accordance with yet another aspect of the present disclosure, the prismatic battery further includes a cell case, an electrolyte and a sealing member. The cell case has an interior cavity and a fill port having an inner surface. The fill port is in communication with an ambient environment and the interior cavity. The electrolyte is disposed in the interior cavity. The sealing member is disposed in the fill port and has an exterior sealing surface and an inner tubular body. The exterior sealing surface forms a fluid seal with the inner surface of the fill port. The inner tubular body has a one-way valve. The one-way valve includes a flap pivotably attached to the tubular body. The one-way valve has an open position for allowing the electrolyte to enter the interior cavity and a closed position to prevent the electrolyte from exiting the interior cavity.

In accordance with yet another aspect of the present disclosure, the prismatic battery cell further includes a closure plate disposed over and covering the sealing member

In accordance with yet another aspect of the present disclosure, the closure plate is secured to the cell case to form a mechanical and a fluid seal between the cell case and the interior cavity.

In accordance with yet another aspect of the present disclosure, the inner surface of the fill port includes a first annular surface and a second annular surface.

In accordance with yet another aspect of the present disclosure, the exterior sealing surface of sealing member has a first sealing annular surface that forms a first fluid seal with the first annular surface of the fill port.

In accordance with yet another aspect of the disclosure, the sealing member has a second sealing annular surface that forms a second fluid seal with the second annular surface of the fill port.

In accordance with yet another aspect of the present disclosure, the first sealing annular surface of the exterior sealing surface of sealing member is formed on an annular rim at a first end of the sealing member.

In accordance with yet another aspect of the disclosure the second sealing annular surface of the exterior sealing surface of sealing member is formed on a conical portion of the sealing member at a second end of the sealing member.

In accordance with still another aspect of the present disclosure, a method for manufacturing a prismatic battery cell includes: filling an interior cavity of a cell case of the prismatic battery cell using a fill port disposed on the cell case with an electrolyte, inserting a sealing member having a one-way valve in the fill port of the cell case, initiating a formation process of the battery cell, inserting a fill tube into the one-way valve of the sealing member, de-gassing the interior cavity of the battery cell, filling an interior cavity of the cell case through the one-way valve of the sealing member, removing the fill tube from the one-way valve of the sealing member.

In accordance with still another aspect of the present disclosure, the method further includes attaching a closure plate over the sealing member and the fill port by welding the closure plate to the cell case.

### BRIEF DESCRIPTION OF THE DRAWINGS

The drawings described herein are for illustration purposes only and are not intended to limit the scope of the present disclosure in any way.

FIG. 1A is a perspective view of a prismatic battery cell, illustrated in accordance with the present disclosure;

FIG. 1B is a magnified view of a partial cross-section through fill port of the battery cell as indicated in FIG. 1A, illustrated in accordance with the present disclosure;

FIG. 2 is a cross-sectional view through the sealing member of the battery cell as indicated in FIG. 1B; and

FIG. 3 a flow chart of a method for manufacturing the prismatic battery cell, in accordance with the present disclosure.

### DETAILED DESCRIPTION

The following description is merely exemplary in nature and is not intended to limit the present disclosure, application, or uses.

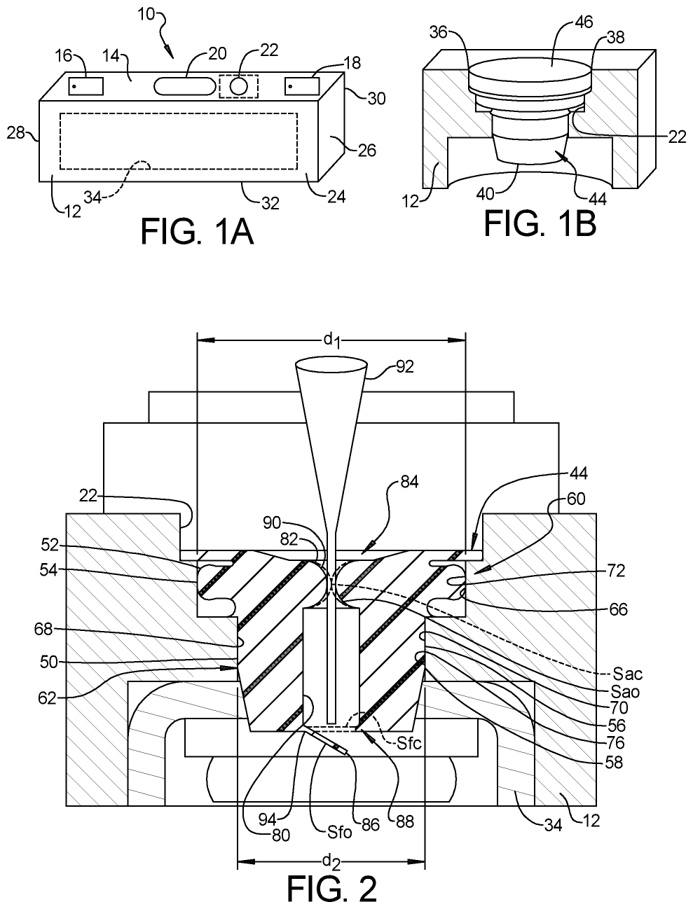

Referring now to FIG. 1A a perspective view of a prismatic battery cell 10 is illustrated, in accordance with the present disclosure. Battery cell 10 has a housing or case 12, a top cap 14, terminals 16 and 18, a vent 20 and an electrolyte injection port or fill port 22. The housing or case 12 is shown schematically in FIG. 1A and has a first side wall 24, a second side wall 26, third side wall 28 (not shown), a fourth side wall 30 (not shown) and a bottom wall or floor 32 (not shown) that define an internal cavity 34. The internal cavity 34 is enclosed by the top cap 14. The present disclosure contemplates other housing configurations for housing or case 12 and is not limited to the exemplary housing shown in FIG. 1A. Additionally, housing 12 is configured to contain or hold a suitable electrolyte. For example, the electrolyte is a liquid solution of organic solvents and lithium salts. Moreover, internal cavity 34 houses a plurality of electrode stacks (not shown) that are submerged in the electrolyte contained in housing 12. The electrode stacks include a negative electrode or anode electrode, a separator, and positive electrode or cathode electrode. Anode electrode is generally a thin metal plate that includes a protruding electrode tab for providing an electrical connection between the anode electrode and the terminal 16 on the exterior of the housing. Similarly, cathode electrode is a thin metal plate that includes a protruding electrode tab for providing an electrical connection between the cathode electrode and terminal 18 on the exterior of the housing. Electrode tabs serve as current collectors. The voltage produced across the anode electrode and cathode electrode is communicated through the terminals on housing 12 to an external device (not shown). The anode electrode and electrode tab are made, for example, of copper or other suitable material and typically coated with graphite or graphite/silicon or other carbon-based materials or silicon oxide or lithiated silicon. The cathode electrode and electrode tab are made, for example, of aluminum or other suitable material and typically coated with a lithium metal oxide, such as Lithium cobalt oxide (LCO) or lithium nickel-cobalt-aluminum (NCA) or lithium nickel-cobalt-manganese-aluminum (NCMA) or lithium iron/manganese phosphate (LFP/LFMP) or Lithium manganese rich (LMR).

The different metals coated with anode and cathode electrode materials (copper anode and aluminum cathode) of prismatic battery 10 produce a galvanic reaction in prismatic battery 10. The graphite, for example, of anode electrode and the LCO, for example, of cathode electrode have different standard reduction potentials and are connected to an external circuit and separated by one another by the separator. The LCO having the lower potential will oxidize and release electrons, while the graphite having a higher potential will reduce and accept electrons. This process of releasing and accepting electrons generates an electric current that may be used to power devices. Separator is generally a thin a porous membrane or layer of material that is positioned between the anode electrode and the cathode electrode and prevents the anode and cathode from touching and causing a short circuit. Separator allows the lithium ions to pass through and complete the circuit. A composite material that is porous and chemically stable such as composites made with polyethylene (PE), polypropylene (PP) or other natural materials of the like may be used as a separator. Moreover, inorganic nanoparticles such as TiO₂, SiO₂, Al₂O₃, AIO (OH) and ZrO₂ may also be used to create coating composites for separator. Separator increases the internal resistance of prismatic battery 10 that may reduce power output and efficiency of the battery. The internal resistance depends on the thickness porosity and composition of separator. Preferably, a thinner, more porous and more conductive separator can lower the resistance and improve performance of the battery 10. Separator is also selected to withstand high temperatures and manage thermal runaway preventing an uncontrollable rise in temperature due to exothermic reactions. Moreover, the separator has a high melting point and a low shrinkage rate to avoid contact between the anode and cathode electrodes. The separator has sufficient mechanical strength to resist puncture, tear, or deformation during fabrication and operation of battery cell 10. The separator also is dimensionally stabile and flexible to conform to the shape of the electrodes and accommodate volume changes during cycling. The separator is chemically inert and compatible with the electrolyte, electrodes, and other cell components. Additionally, separator has a low affinity for water or other impurities that can contaminate the electrolyte or cause corrosion of the electrodes.

With continuing reference to FIG. 1A, a vent 20 is provided in the top cap 14 at a suitable location on the surface of the top cap 14. Alternatively, the vent 20 may be located on the bottom of the housing 12. The vent 20 is in fluid communication with the internal cavity 34 of the housing 12. The vent 20 is formed of a gas permeable barrier such as a material similar to the material used to form the housing 12, however, the vent material is thinner than the housing 12. Excessive pressure in the housing 12 due to gas production is reduced by releasing the gas through vent 20.

The fill port 22 provides a means during the manufacturing process of the battery cell 10 to fill the internal cavity 34 of the housing 12 with the electrolyte. The fill port 22 includes an aperture 36 (shown in FIG. 1B). Aperture 36 is in fluid communication with the ambient environment at a first end 38 and with the internal cavity 34 of housing 12 at a second end 40.

With reference now to FIG. 1B, a partial cross-sectional magnified view through the housing 12 at the fill port 22 is illustrated, in accordance with the present disclosure. During assembly of battery cell 10, which will be described in greater detail below, a one-way valve or sealing member 44 is disposed in the aperture 36 of fill port 22. Sealing member 32 provides a means to fill the internal cavity 34 with the electrolyte and allow gas to escape internal cavity 34 during the battery cell manufacturing process, as will be described in greater detail below. Moreover, in an aspect of the present disclosure a fill port closure plate 46 is provided to seal the fill port 22 after the manufacturing process is complete.

With reference to FIG. 2, a cross-sectional view through the sealing member 44 is illustrated, in accordance with an aspect of the disclosure. Sealing member 44 is disposed in electrolyte fill port 22 and functions to allow the electrolyte to enter the internal cavity 34 and prevent the electrolyte from exiting the internal cavity 34. Sealing member 44 has an exterior sealing surface 50 for forming a fluid seal with the fill port 22. The exterior sealing surface 50 includes a first annular rim 52 having a first sealing surface 54 and an annular conical portion 56 having a second sealing surface 58. The first sealing surface 54 is disposed at a first end 60 of the sealing member 44 and the second sealing surface 58 is disposed at a second end 62 of the sealing member 44.

The sealing member 44 is formed of a polymer or a polymer composite. In an aspect of the present disclosure, the polymer or polymer composite is a silicone or a polyphenylene sulfide or the like. The sealing member 44 plastically deforms at sealing surface 54, 58 to form a fluid tight seal with the fill port 22.

Fill port 22 has a first aperture portion 66 having a first diameter d₁ and a second aperture portion 68 having a second diameter d₂. The first diameter d₁ of the first aperture portion 66 is larger than the second diameter d₂ of the second aperture 68. An interior surface 70 of the fill port 22 is configured to form a fluid seal with the sealing member 44. Moreover, the interior surface 70 of fill port 22 includes a first interior surface 72 of the first aperture 66 of the fill port 22 and a second interior surface 76 of the second aperture 68. More specifically, the fluid seal is formed by an interference fit of the sealing member 44 within the fill port 22. The interference fit causes the first sealing surface 54 of the first annular rim 52 to deform and contact the first interior surface 72 of the first aperture 66 and second sealing surface 58 of the annular conical portion 56 to contact the second interior surface 76 of the second aperture 68. As such the fluid seal is formed to prevent the electrolyte from escaping the internal cavity 34 of the battery cell 10.

Sealing member 44 also functions to allow the internal cavity to be filled with the electrolyte while the sealing member 44 is disposed in the fill port 22. Accordingly, the sealing member 44 includes an inner tubular body 80. The inner tubular body 80 has an annulus 82 at a first end 84 of inner tubular body 80 and a pivotable flap 86 at a second end 88 to selectively enclose the inner tubular body 80 forming a one-way valve. The annulus 82 has a central opening 90. The central opening 90 of annulus 82 and the pivotable flap 86 may be positioned in an open state “Sₐₒ” and S_{fo}” to allow fluid (i.e. electrolyte) to enter the internal cavity 34 of the battery cell 10 and in a closed state “S_{ac}” and S_{fc}” to allow fluid to exit the internal cavity 34. The central opening 90 and pivotable flap 86 are biased in the closed position or state S_{ac} and S_{fc}, thus creating the one-way fluid seal or valve preventing fluid from exiting the internal cavity 34.

Central opening 90 of annulus 82 and pivotable flap 86 are positioned in the open state Sₐₒ and S_{fo} by a force applied by the introduction of a conduit or needle or funnel 92. More specifically, funnel 92 is placed in the annulus 82 and pushed inward into the inner tubular body 80 of sealing member 44 and against the pivotable flap 86. The introduction of funnel 92 causes the annulus 82 to plastically deform allowing the funnel to pass through the annulus 82. Upon further advancement of the funnel 92 into the inner tubular body 80 and against the pivotable flap 86, the pivotable flap 86 is plastically deformed at a hinge portion 94 allowing the flap 86 to open and rotate away from the end 88 of the inner tubular body 80 and allow fluid to pass into the internal cavity 34. Upon removal of the funnel 92 the annulus 82 closes and returns to its original shape or state S_{ac} and the flap 86 returns (rotates towards the open end 88) to its original position enclosing the end 88 of inner tubular body 80 and returning to the closed position or state S_{fc}.

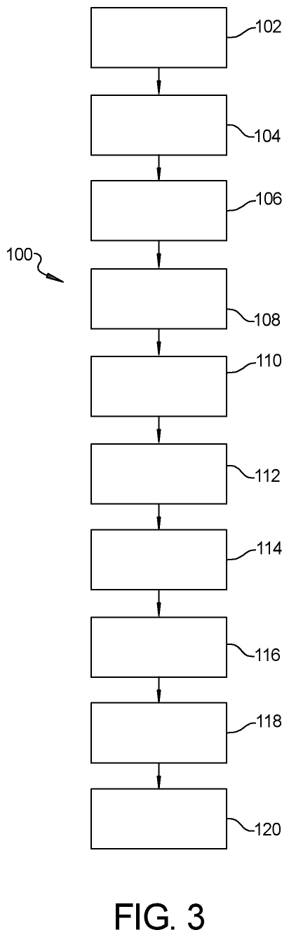

Referring now to FIG. 3, a flow chart of a method 100 for manufacturing a battery cell 10 is illustrated, in accordance with the present disclosure. Method 100 starts at block 102, a block 102 the dry or empty prismatic battery cell case is positioned for electrolyte filling. At block 104, the electrolyte is deposited into the internal cavity of the battery cell through the fill port 22. At block 106, the sealing member 44 is pressed into the fill port 22 forming a fluid seal, as described above. A formation process is initiated at block 108. During formation a current is applied to and removed from the electrodes of the battery cell 10 at a specified temperature to charge and discharge the battery cell for the first time, thereby conditioning the battery cell's internal structure. A solid-electrolyte interface is formed on the anode electrode. The solid-electrolyte interface is important for stability and lifespan of the battery cell. Additionally, gas is produced during the formation process and must be released from the internal cavity 34 of the battery cell 10. At block 110, the funnel 92 is inserted into the inner tubular body 80 of sealing member 44 to force the annulus 82 of the sealing member 44 into the open state Sₐₒ and the flap 86 into the open state S_{fo}. De-gassing or removal of the gas produced during the formation process is provided at block 112, where the gas is released through the funnel 92. At block 114, the electrolyte is again deposited into the internal cavity 34 of the battery cell 10 through the funnel 92. Once the electrolyte substantially fills the internal cavity 34, the funnel 92 is removed at block 116, causing the annulus 82 and the flap 86 to return to the closed position or state S_{ac} and S_{fc}. At block 118, the closure plate 46 is applied over the sealing member 44 and covering the fill port 22. At block 120, the closure plate 46 is welded to the battery cell case 12.

The present disclosure has many advantages and benefits over existing systems and methods for manufacturing a prismatic battery cell. For example, is some aspects of the present disclosure the process for manufacturing the prismatic battery cell is simplified. More specifically, the sealing member 44 of the present disclosure reduces the number of steps necessary to fill the battery cell with electrolyte, de-gas the battery cell and then refill the battery cell with electrolyte. Thus, the overall time necessary to manufacture the battery cell is reduced.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A prismatic battery comprising:
a cell case having an interior cavity and a fill port having an inner surface, wherein the fill port is in fluid communication with an ambient environment and the interior cavity;
an electrolyte disposed in the interior cavity;
a sealing member disposed in the fill port, wherein the sealing member has an exterior sealing surface that forms a fluid seal with the inner surface of the fill port, and wherein the sealing member has a valve formed in the sealing member; and
wherein the valve has an open position for allowing the electrolyte to enter the interior cavity and a closed position to prevent the electrolyte from exiting the interior cavity.

2. The prismatic battery of claim 1 further comprising a closure plate disposed over and covering the sealing member.

3. The prismatic battery of claim 2 wherein the closure plate is secured to the cell case to form a mechanical and a fluid seal between the cell case and the interior cavity.

4. The prismatic battery of claim 1 wherein the inner surface of the fill port includes a first annular surface and a second annular surface.

5. The prismatic battery of claim 4 wherein the exterior sealing surface of sealing member has a first sealing annular surface that forms a first fluid seal with the first annular surface of the fill port.

6. The prismatic battery of claim 5 wherein the sealing member has a second sealing annular surface that forms a second fluid seal with the second annular surface of the fill port.

7. The prismatic battery of claim 5 wherein the first sealing annular surface of the exterior sealing surface of sealing member is formed on an annular rim at a first end of the sealing member.

8. The prismatic battery of claim 7 wherein the second sealing annular surface of the exterior sealing surface of sealing member is formed on a conical portion of the sealing member at a second end of the sealing member.

9. The prismatic battery of claim 1 wherein the valve further comprises a tubular body having an inner annular rim at a first end, wherein the inner annular rim forms an annulus, and a flap at a second end of the tubular body, and wherein the flap is sealed against the tubular body in the closed position of the valve to form a fluid seal and the flap and disposed away from the tubular body in the open position of the valve to allow for fluid communication with the interior cavity.

10. The prismatic battery of claim 1 wherein the sealing member is formed of at least one of a polymer and a polymer composite.

11. A prismatic battery comprising:
a cell case having an interior cavity and a fill port having an inner surface, wherein the fill port is in communication with an ambient environment and the interior cavity;
an electrolyte disposed in the interior cavity; and
a sealing member disposed in the fill port and having an exterior sealing surface and an inner tubular body, wherein the exterior sealing surface forms a fluid seal with the inner surface of the fill port, and the inner tubular body has a one-way valve, wherein the one-way valve includes a flap pivotably attached to the tubular body; and
wherein the one-way valve has an open position for allowing the electrolyte to enter the interior cavity and a closed position to prevent the electrolyte from exiting the interior cavity.

12. The prismatic battery of claim 11 further comprising a closure plate disposed over and covering the sealing member.

13. The prismatic battery of claim 12 wherein the closure plate is secured to the cell case to form a mechanical and a fluid seal between the cell case and the interior cavity.

14. The prismatic battery of claim 11 wherein the inner surface of the fill port includes a first annular surface and a second annular surface.

15. The prismatic battery of claim 14 wherein the exterior sealing surface of sealing member has a first sealing annular surface that forms a first fluid seal with the first annular surface of the fill port.

16. The prismatic battery of claim 15 wherein the sealing member has a second sealing annular surface that forms a second fluid seal with the second annular surface of the fill port.

17. The prismatic battery of claim 16 wherein the first sealing annular surface of the exterior sealing surface of the sealing member is formed on an annular rim at a first end of the sealing member.

18. The prismatic battery of claim 17 wherein the second sealing annular surface of the exterior sealing surface of the sealing member is formed on a conical portion of the sealing member at a second end of the sealing member.

19. A method for manufacturing a prismatic battery cell comprising:
filling an interior cavity of a cell case of the prismatic battery cell using a fill port disposed on the cell case with an electrolyte;
inserting a sealing member having a one-way valve in the fill port of the cell case;
initiating a formation process of the battery cell;
inserting a fill tube into the one-way valve of the sealing member;
de-gassing the interior cavity of the battery cell;
filling an interior cavity of the cell case through the one-way valve of the sealing member; and
removing the fill tube from the one-way valve of the sealing member.

20. The method of claim 19 further comprising attaching a closure plate over the sealing member and the fill port by welding the closure plate to the cell case.
